(19) United States
(12) Patent Application Publication
(10) Pub. No.: US 2025/0272820 A1
(43) Pub. Date: Aug. 28, 2025

(54) SYSTEM, APPARATUS, AND METHOD FOR DETECTING SHAPE FAULT OF ELECTRODE TAB OF SECONDARY BATTERY

(71) Applicant: SK ON CO., LTD., Seoul (KR)

(72) Inventors: Oh Jae KWON, Daejeon (KR); Jae Yeon KIM, Daejeon (KR); Chang Hun CHA, Daejeon (KR); Hyo Sung HONG, Daejeon (KR)

(21) Appl. No.: 19/066,384

(22) Filed: Feb. 28, 2025

(30) Foreign Application Priority Data
Feb. 28, 2024 (KR) 10-2024-0028995

(51) Int. Cl. G06T 7/00; G06T 7/60; G06V 10/766; H01M 50/564

(52) U.S. Cl. CPC G06T 7/0004; G06T 7/60; G06V 10/766; H01M 50/564

(57) ABSTRACT

The present disclosure provides a method, device and system for detecting a shape fault of an electrode tab of a secondary battery. The method according to an embodiment of the present disclosure may include: photographing a side surface of the secondary battery to acquire a side surface image of the electrode tab processed into a designated shape; measuring a bending radius and a cutting distance of the processed electrode tab from the side surface image; checking whether the bending radius and the cutting distance satisfy a designated reference radius and reference distance; and if the bending radius and the cutting distance do not satisfy the reference radius and the reference distance, determining that the shape fault of the electrode tab has occurred.

### CROSS-REFERENCE TO RELATED APPLICATION(S)

This patent document claims the priority and benefits of Korean Patent Application No. 10-2024-0028995 filed on Feb. 28, 2024, the disclosure of which is incorporated herein by reference in its entirety.

### BACKGROUND OF THE INVENTION

### 1. Field of the Invention

The present disclosure relates to a method, device and system for detecting a shape fault of an electrode tab of a secondary battery.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a tablet personal computer (PC), a laptop PC, etc. as a power source thereof. Recently, a battery pack including the secondary battery has also been developed as a power source of an eco-friendly automobile such as an electric vehicle.

Meanwhile, when manufacturing the secondary battery, various faults may occur. For example, a pouch-type secondary battery requires processing (e.g., bending and cutting) of an electrode tab when assembling a pouch cell (or a pouch case), and dimensional management of the shape of the processed electrode tab is essential. However, the pouch-type secondary battery has a problem in that material deformation may easily occur due to characteristics of the electrode tab. Meanwhile, there is a problem that it is difficult to appropriately set a reference point (or reference position) for managing shape dimensions of the electrode tab. For example, currently, a user specifies a region of interest for setting the reference point. Therefore, the current method has a problem in that human error may occur.

Thereby, in recent years, a method that can clearly set a reference point, minimize an error in the dimensional measurement of the shape of the electrode tab, and improve the performance (e.g., measurement speed) is required.

### SUMMARY OF THE INVENTION

An object of the present disclosure is to provide a method, device and system for detecting a shape fault of an electrode tab of a secondary battery, which may improve accuracy and/or reliability of shape fault detection of the electrode tab.

Another object of the present disclosure is to provide a method, device and system for detecting a shape fault of an electrode tab of a secondary battery, which may improve speed of shape fault detection of the electrode tab.

The method, device and system for detecting a shape fault of an electrode tab of a secondary battery of the present disclosure may be widely applied to green technology fields such as an electric vehicle, and a battery charging station, as well as solar power generation and wind power generation using batteries. In addition, the method, device and system for detecting a shape fault of an electrode tab of a secondary battery of the present disclosure may be used in an eco-friendly electric vehicle, a hybrid vehicle, and the like, intended to prevent climate change by suppressing air pollution and greenhouse gas emissions.

To achieve the above object, according to an aspect of the present invention, there is provided a method for detecting a shape fault of an electrode tab of a secondary battery, which includes: photographing a side surface of the secondary battery to acquire a side surface image of the electrode tab processed into a designated shape; measuring a bending radius and a cutting distance of the processed electrode tab from the side surface image; checking whether the bending radius and the cutting distance satisfy a designated reference radius and reference distance; and if the bending radius and the cutting distance do not satisfy the reference radius and the reference distance, determining that the shape fault of the electrode tab has occurred.

According to an embodiment, the measuring step may include: setting a first region of interest to include a partial region of an end (hereinafter, a cutting part) of the processed electrode tab; generating an upper parallel line corresponding to an upper end of the cutting part and a lower parallel line corresponding to a lower end in the first region of interest; recognizing a first end point of the upper parallel line and a second end point of the lower parallel line; setting a second region of interest to include a bending part of the processed electrode tab, and setting a third region of interest with a designated size within the second region of interest; recognizing upper boundary points and lower boundary points of the bending part while moving the third region of interest by a designated unit; determining a starting point and a peak point of the bending part based on the recognized upper boundary points and lower boundary points; and calculating the bending radius and the cutting distance based on the determined starting point and peak point of the bending part.

According to an embodiment, the step of generating the upper parallel line and the lower parallel line may include: generating a first straight line based on the upper boundary points of the cutting part of the electrode tab using a linear regression technique, and determining the generated first straight line as the upper parallel line; and generating a second straight line based on the lower boundary points of the cutting part of the electrode tab using the linear regression technique, and determining the generated second straight line as the lower parallel line.

According to an embodiment, the step of determining the starting point of the bending part may include determining an upper boundary point where a vertical distance from the upper parallel line starts to be a designated size or less among the recognized upper boundary points of the bending part as an upper starting point; and determining a lower boundary point where a vertical distance from the lower parallel line starts to be a designated size or less among the recognized lower boundary points of the bending part as a lower starting point.

According to an embodiment, the step of calculating the cutting distance may include calculating an upper tab distance between the first end point and a point where a straight line vertically extending from the upper starting point and the upper parallel line meet; calculating a lower tab distance between the second end point and a point where a straight line vertically extending from the lower starting point and the lower parallel line meet; and determining an average of the upper tab distance and the lower tab distance as the cutting distance.

According to an embodiment, the step of determining the peak point may include determining an upper boundary point which has the largest vertical distance from the lower parallel line among the recognized upper boundary points of the bending part as the peak point.

According to an embodiment, the step of calculating the bending radius may include calculating a vertical distance between the peak point and the lower parallel line; and determining the calculated vertical distance as the bending radius.

According to an embodiment, the method may further include calculating a bending distance of the electrode tab based on the second end point and the peak point of the electrode tab.

According to an embodiment, the method may further include: recognizing a pattern of a shape of the electrode tab from the side surface image; and if the pattern is not recognized, generating an alarm to notify that the pattern recognition is not possible, wherein, when the pattern is recognized, the measuring step is performed.

According to an embodiment, the method may further include, when it is determined that the shape fault has occurred, generating an alarm in a designated manner.

In addition, according to another aspect of the present invention, there is provided an apparatus for detecting a shape fault of an electrode tab of a secondary battery, which includes: a photographing module configured to photograph a side surface of the secondary battery to acquire a side surface image of the electrode tab processed into a designated shape; and a processor configured to measure a bending radius and a cutting distance of the processed electrode tab from the side surface image, check whether the bending radius and the cutting distance satisfy a designated reference radius and reference distance, and if the bending radius and the cutting distance do not satisfy the reference radius and the reference distance, determine that the shape fault of the electrode tab has occurred.

According to an embodiment, the processor may set a first region of interest to include a partial region of an end (hereinafter, a cutting part) of the processed electrode tab, generate an upper parallel line corresponding to an upper end of the cutting part and a lower parallel line corresponding to a lower end in the first region of interest, recognize a first end point of the upper parallel line and a second end point of the lower parallel line, set a second region of interest to include a bending part of the processed electrode tab, and set a third region of interest with a designated size within the second region of interest, recognizes upper boundary points and lower boundary points of the bending part while moving the third region of interest by a designated unit, determine a starting point and a peak point of the bending part based on the recognized upper boundary points and lower boundary points, and calculate the bending radius and the cutting distance based on the determined starting point and peak point of the bending part.

According to an embodiment, the processor may generate a first straight line based on the upper boundary points of the cutting part of the electrode tab using a linear regression technique, and determine the generated first straight line as the upper parallel line, and generate a second straight line based on the lower boundary points of the cutting part of the electrode tab using the linear regression technique, and determine the generated second straight line as the lower parallel line.

According to an embodiment, the processor may determine an upper boundary point where a vertical distance from the upper parallel line starts to be a designated size or less among the recognized upper boundary points of the bending part as an upper starting point, and determine a lower boundary point where a vertical distance from the lower parallel line starts to be a designated size or less among the recognized lower boundary points of the bending part as a lower starting point.

According to an embodiment, the processor may calculate an upper tab distance between the first end point and a point where a straight line vertically extending from the upper starting point and the upper parallel line meet, calculate a lower tab distance between the second end point and a point where a straight line vertically extending from the lower starting point and the lower parallel line meet, and determine an average of the upper tab distance and the lower tab distance as the cutting distance.

According to an embodiment, the processor may determine an upper boundary point which has the largest vertical distance from the lower parallel line among the recognized upper boundary points of the bending part as the peak point.

According to an embodiment, the processor may calculate a vertical distance between the peak point and the lower parallel line, and determine the calculated vertical distance as the bending radius.

According to an embodiment, the processor may further calculate a bending distance of the electrode tab based on the second end point and the peak point of the electrode tab.

According to an embodiment, the apparatus may further include an alarm module configured to, when it is determined that the shape fault has occurred, generate an alarm in a designated manner.

Further, according to another aspect of the present invention, there is provided a system for detecting a shape fault of an electrode tab of a secondary battery, which includes: a processing apparatus configured to process the electrode tab of the secondary battery into a designated shape; and an electrode tab inspection apparatus configured to photograph a side surface of the secondary battery through a photographing module to acquire a side surface image of the electrode tab processed into a designated shape, measure a bending radius and a cutting distance of the processed electrode tab from the side surface image, and compare the bending radius and the cutting distance with a designated reference radius and reference distance, respectively, to inspect whether there is a shape fault of the electrode tab.

According to an embodiment, the present disclosure may improve the accuracy and/or reliability of shape fault detection of the electrode tab. For example, the present disclosure may clearly set a reference point for shape measurement of the electrode tab and prevent human error. Accordingly, the present disclosure may improve the accuracy and/or reliability of shape fault detection of the electrode tab.

In addition, the present disclosure may improve the speed and/or efficiency of shape fault detection of the electrode tab. For example, the present disclosure may measure the bending radius and the cutting distance of the processed electrode tab through one process. Accordingly, the present disclosure may improve the speed and/or efficiency of shape fault detection of the electrode tab.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating a system for detecting a shape fault of an electrode tab of a secondary battery according to an embodiment of the present disclosure;

FIG. 2 is a view for describing a method for processing an electrode tab of a secondary battery according to an embodiment of the present disclosure;

FIG. 3 is a flowchart for describing procedures of a method for detecting a shape fault of an electrode tab of a secondary battery according to an embodiment of the present disclosure;

FIG. 4 is a view for describing a method for generating an upper parallel line and a lower parallel line according to an embodiment of the present disclosure;

FIGS. 5a, 5b and 5c are views for describing a method for setting a starting point and a peak point of a bending part according to an embodiment of the present disclosure;

FIG. 6 is a view for describing a method for calculating a bending radius, a cutting distance, and a bending distance according to an embodiment of the present disclosure; and

FIG. 7 is a block diagram illustrating the configuration of an apparatus for detecting a shape fault of an electrode tab of a secondary battery according to an embodiment of the present disclosure.

### DETAILED DESCRIPTION OF THE INVENTION

Hereinafter, the present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

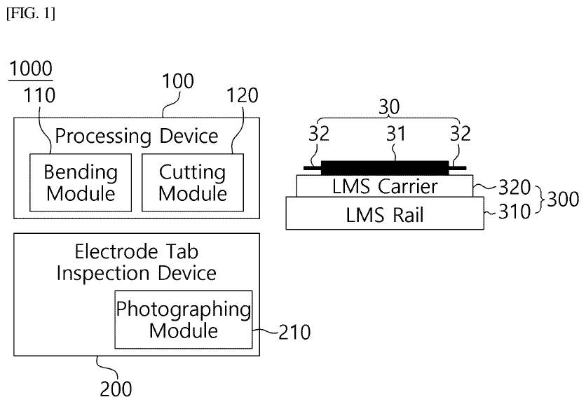

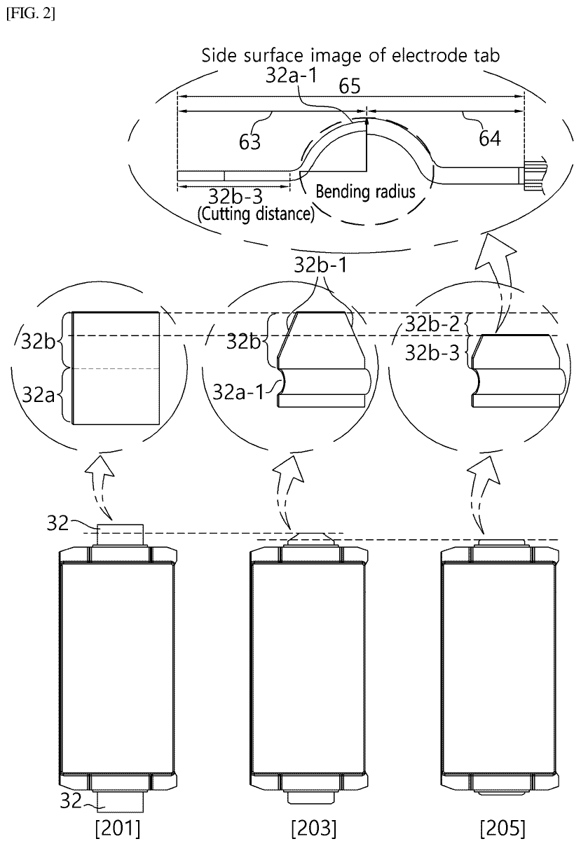

FIG. 1 is a view schematically illustrating a system for detecting a shape fault of an electrode tab of a secondary battery according to an embodiment of the present disclosure, and FIG. 2 is a view for describing a method for processing an electrode tab of a secondary battery according to an embodiment of the present disclosure.

Referring to FIGS. 1 and 2, a system 1000 for detecting a shape fault of an electrode tab (e.g., a cathode tab and/or an anode tab) of a secondary battery 30 (hereinafter, “a system)” according to an embodiment of the present disclosure may include a processing apparatus 100, an electrode tab inspection apparatus 200, and a transfer apparatus 300.

The transfer apparatus 300 may transfer the secondary battery 30. For example, the transfer apparatus 300 may control the transfer of the secondary battery 30 being manufactured according to a process procedure for manufacturing the secondary battery 30. According to an embodiment, the transfer apparatus 300 may transfer the secondary battery 30 to the processing apparatus 100 for processing (e.g., bending and cutting) an electrode tab of the secondary battery 30. In addition, the transfer apparatus 300 may transfer the secondary battery 30 to the electrode tab inspection apparatus 200 to inspect whether the secondary battery 30 is defective (e.g., inspect whether there is a shape fault of the electrode tab). The transfer apparatus 300 may include a linear motion system (LMS). The transfer apparatus 300 may include a rail 310 forming a movement path and a carrier 320 on which the secondary battery 30 is placed on an upper surface, and moves along the rail 310.

The processing apparatus 100 may process the electrode tab 32 of the secondary battery 30. For example, the processing apparatus 100 may process (e.g., bend and cut) the electrode tab 32 of the secondary battery 30 transferred by the transfer apparatus 300. Specifically, the processing apparatus 100 may press a partial region (e.g., an inner part) 32a of the electrode tab 32 through a bending module 110 to bend it into a designated shape, as shown by a reference numeral 201 in FIG. 2 of the drawing. Thereafter, the processing apparatus 100 may cut a corner 32b-1 of an outer part 32b diagonally (hereinafter, “a primary cut”) through a cutting module 120, as shown by a reference numeral 203 in FIG. 2 of the drawing. In addition, the processing apparatus 100 may cut a portion 32b-2 of an end of the diagonally cut outer part 32b (hereinafter, “a secondary cutting”), as shown by a reference numeral 205 in FIG. 2 of the drawing. In other words, the electrode tab 32 may be processed to include a bending part 32a-1 having a designated bending radius and a cutting part 32b-3 having a designated cutting distance. The secondary battery 30 on which the processing of the electrode tab 32 is completed may be transferred to the electrode tab inspection apparatus 200 by the transfer apparatus 300.

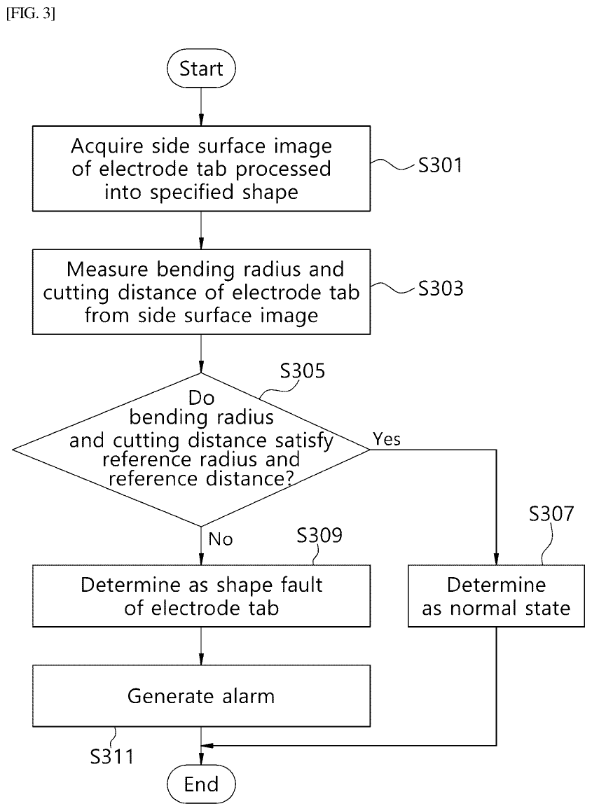

The electrode tab inspection apparatus 200 may inspect whether the secondary battery 30 is defective. For example, the electrode tab inspection apparatus 200 may inspect whether there is a shape fault of the electrode tab 32 processed by the processing apparatus 100. Specifically, after the electrode tab 32 is processed (bent and cut) by the processing apparatus 100, the electrode tab inspection apparatus 200 may photograph a side surface of the secondary battery 30 through a photographing module 210 (e.g., a camera) to acquire a side surface image of the processed electrode tab 32, measure a bending radius and a cutting distance through the side surface image, and compare the measured bending radius and cutting distance with a designated reference radius and reference distance, respectively, to inspect whether there is a shape fault of the electrode tab 32. For example, if the measured bending radius and cutting distance do not satisfy the designated reference radius and reference distance, the electrode tab inspection apparatus 200 may determine that there is a shape fault of the electrode tab. Detailed processes of a method for measuring the bending radius and the cutting distance will be described in detail below with reference to FIGS. 3 to 6.

When it is determined that there is a shape fault (e.g., a fault in the bending radius and/or cutting distance) of the electrode tab 32, the electrode tab inspection apparatus 200 may generate an alarm in a designated manner (e.g., auditory, visual, tactile, etc.).

Meanwhile, the electrode tab inspection apparatus 200 may further calculate a bending distance 63 (e.g., a distance between a center of the bending part 32a-1 and an end point of the electrode tab) of the secondary battery 30. The bending distance 63 may be a value obtained by adding a bending radius of the bending part 32a-1 to a cutting distance of the cutting part 32b-3. The electrode tab inspection apparatus 200 may check the alignment performance of the processing apparatus 100 for processing (e.g., bending and cutting) the electrode tab using the bending distance 63. Specifically, the electrode tab inspection apparatus 200 may calculate an alignment distance 64 (e.g., a difference between an entire distance 65 of the processed electrode tab and the bending distance 63) using the bending distance 63, and if the alignment distances 64 calculated for a plurality of secondary batteries are not constant, it may be determined that there is a problem with the alignment of the secondary batteries 30.

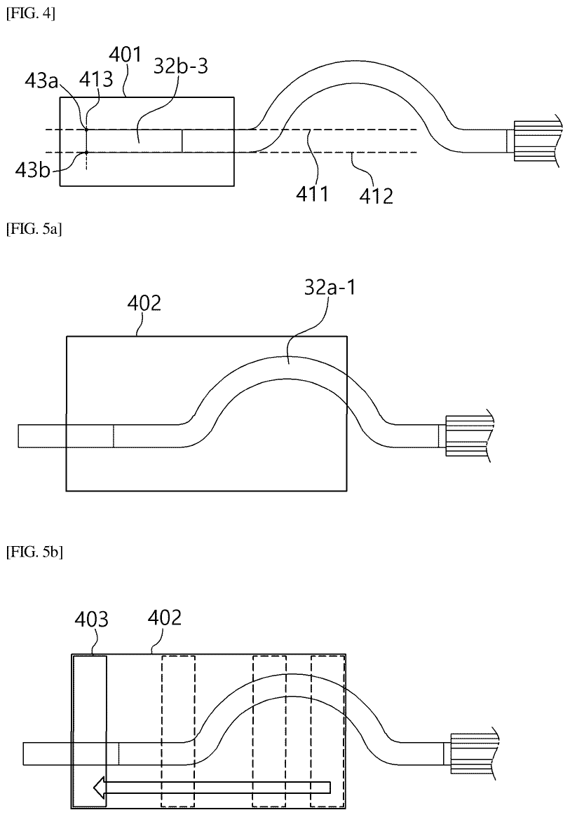

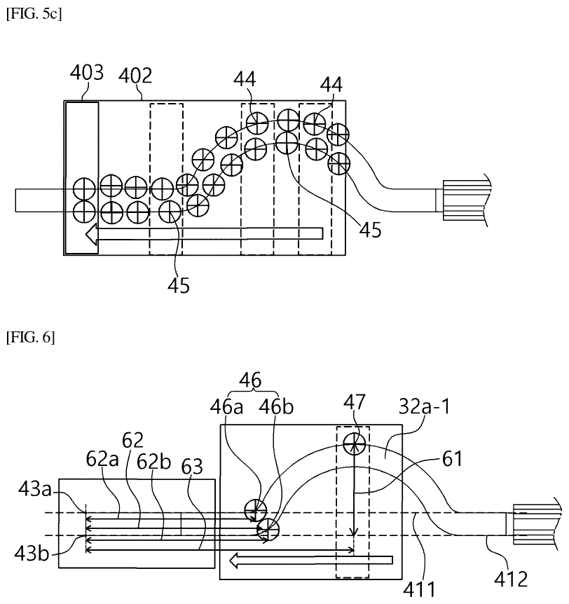

FIG. 3 is a flowchart for describing procedures of a method for detecting a shape fault of an electrode tab of a secondary battery according to an embodiment of the present disclosure, FIG. 4 is a view for describing a method for generating an upper parallel line and a lower parallel line according to an embodiment of the present disclosure, FIGS. 5a, 5b and 5c are views for describing a method for setting a starting point and a peak point of a bending part according to an embodiment of the present disclosure, and FIG. 6 is a view for describing a method for calculating a bending radius, a cutting distance, and a bending distance according to an embodiment of the present disclosure.

Referring to FIGS. 3 to 6, the method for detecting a shape fault of an electrode tab of a secondary battery according to an embodiment of the present disclosure may include a step (S301) of acquiring a side surface image of the electrode tab processed (e.g., bent and cut) into a designated shape. For example, the electrode tab inspection apparatus may photograph a side surface of the secondary battery through a photographing module (e.g., the camera) to acquire a side surface image of the electrode tab processed into the designated shape.

The method may include a step (S303) of measuring a bending radius and a cutting distance of the electrode tab from the side surface image. Specifically, the electrode tab inspection apparatus may generate an upper parallel line and a lower parallel line of a cutting part of the electrode tab from the side surface image, and recognize an end point of the electrode tab. For example, as shown in FIG. 4, the electrode tab inspection apparatus may set a first region of interest 401 to include the cutting part 32b-3 of the electrode tab (e.g., a partial region of an end of the processed electrode tab), and generate an upper parallel line 411 corresponding to an upper end of the cutting part 32b-3 and a lower parallel line 412 corresponding to a lower end of the cutting part 32b-3 in the set first region of interest 401. According to an embodiment, the electrode tab inspection apparatus may generate a straight line based on upper boundary points of the cutting part 32b-3 of the electrode tab using a linear regression technique, and determine the generated straight line as the upper parallel line 411. In addition, the electrode tab inspection apparatus may generate a straight line based on lower boundary points of the cutting part 32b-3 of the electrode tab using the linear regression technique, and determine the generated straight line as the lower parallel line 412.

Meanwhile, the electrode tab inspection apparatus may recognize a first end point of the upper parallel line 411 and a second end point of the lower parallel line 412. For example, the electrode tab inspection apparatus may recognize an end 413 (e.g., a vertical boundary line) of the cutting part 32b-3, recognize a point where the end 413 and the upper parallel line 411 meet as a first end point 43a, and recognize (or detect) a point where the end 413 and the lower parallel line 412 meet as a second end point 43b.

Next, the electrode tab inspection apparatus may recognize an upper boundary point and a lower boundary point of the bending part of the electrode tab (e.g., a region 32a-1 bent into a designated shape (e.g., a semicircle)). For example, as shown in FIGS. 5a to 5c, the electrode tab inspection apparatus may set a second region of interest 402 to include the bending part 32a-1 of the electrode tab, set a third region of interest 403 with a designated size (e.g., a size having a similar height to and a smaller width than the second region of interest 402) within the second region of interest 402, and recognize (or detect) upper boundary points 44 and lower boundary points 45 of the bending part 32a-1 while moving the third region of interest 403 by a designated unit (e.g., moving from a right end to a left end of the second region of interest 402).

Next, the electrode tab inspection apparatus may calculate a bending radius 61 and a cutting distance 62. First, as shown in FIG. 6, the electrode tab inspection apparatus may determine a starting point 46 and a peak point 47 of the bending part 32a-1 based on the recognized upper boundary points 44 and lower boundary points 45. Specifically, the electrode tab inspection apparatus may determine an upper boundary point where a vertical distance from the upper parallel line 411 starts to be a designated size (e.g., 1.5 pixels) or less (or to be less than the designated size) among the recognized upper boundary points 44 of the bending part 32a-1 as an upper starting point 46a, and may determine a lower boundary point where a vertical distance from the lower parallel line 412 starts to be a designated size or less among the recognized lower boundary points 45 of the bending part 32a-1 as a lower starting point 46b. Meanwhile, the electrode tab inspection apparatus may determine an upper boundary point which is located farthest (e.g., has the largest vertical distance) from the lower parallel line 412 among the recognized upper boundary points 44 of the bending part 32a-1 as the peak point 47.

Next, as shown in FIG. 6, the electrode tab inspection apparatus may calculate the bending radius 61 and the cutting distance 62 based on the determined peak point 47 and the starting point 46 of the bending part 32a-1. For example, the electrode tab inspection apparatus may calculate a vertical distance between the peak point 47 and the lower parallel line 412, and determine the calculated vertical distance as the bending radius 61. Meanwhile, the electrode tab inspection apparatus may calculate an upper tab distance 62a between the first end point 43a and a point where a straight (perpendicular) line vertically extending from the upper starting point 46a and the upper parallel line 411 meet, calculate a lower tab distance 62b between the second end point 43b and a point where a straight (perpendicular) line vertically extending from the lower starting point 46b and the lower parallel line 412 meet, and determine an average of the upper tab distance 62a and the lower tab distance 62b as the cutting distance 62.

The method may include a step (S305) of checking whether the measured bending radius and cutting distance satisfy the designated reference radius and reference distance. For example, the electrode tab inspection apparatus may compare the measured bending radius and cutting distance with the reference radius and reference distance, respectively, and check whether the measured bending radius and cutting distance satisfy the reference radius and reference distance. According to an embodiment, the reference radius and reference distance may have a range value rather than a specific value.

As a result of the check in the step S305, when the measured bending radius and cutting distance satisfy the reference radius and reference distance, the method may proceed to a step (S307) of determining whether the shape of the electrode tab is normal. On the other hand, as a result of the check in the step S305, if the measured bending radius and cutting distance do not satisfy (e.g., at least one of the bending radius and the cutting distance does not satisfy) the reference radius and reference distance, the method may proceed to a step (S309) of determining that the shape fault of the electrode tab has occurred.

The method may include a step (S311) of generating an alarm. For example, the electrode tab inspection apparatus may generate an alarm to notify an occurrence of the shape fault of the electrode tab in a designated manner (for example, a visual alarm (e.g., lighting a light emitting diode (LED), displaying an icon, displaying a pop-up window, etc.), an auditory alarm (e.g., outputting a sound effect), and/or a tactile alarm (e.g., generating a vibration)).

Meanwhile, although not shown in FIG. 3, the method may further include a step of transmitting an alarm to notify an occurrence of the shape fault of the electrode tab to a designated external device (e.g., a smart phone of the manager) through a communication module (not shown).

In addition, the method may further calculate the bending distance 63 of the electrode tab based on the second end point and the peak point of the electrode tab. For example, as shown in FIG. 6, the electrode tab inspection apparatus may determine a distance between the second end point 43b and a point where a straight (perpendicular) line vertically extending from the peak point 47 and the lower parallel line 412 meet as a bending distance 63. Through this, the present disclosure may provide an effect of being able to check the alignment performance of the processing apparatus. For example, the present disclosure may measure an entire distance of the processed electrode tab, and subtract the bending distance 63 from the measured entire distance to calculate an alignment distance. Thereafter, the present disclosure may compare the calculated alignment distances for a plurality of secondary batteries, and if the alignment distances are not constant (for example, if a difference greater than a designated value occurs), it may be determined that there is a problem with the alignment of the secondary batteries.

In addition, the method may recognize a pattern of the shape of the electrode tab from the side surface image, and if the pattern is not recognized, generate an alarm to notify that the pattern recognition is not possible, and if the pattern is recognized, and perform a step (S303) of measuring the bending radius and the cutting distance. In addition, if the first region of interest 401 cannot be designated from the side surface image, the method may generate an alarm to notify it. In addition, if the upper starting point 46a, the lower starting point 46b, and/or the peak point 47 cannot be recognized, the method may generate an alarm to notify it.

The present disclosure described above may clearly set a reference point (or reference position) for measuring the bending radius and the cutting distance for determining whether there is a shape fault of the electrode tab. For example, the present disclosure may accurately set a reference point (or reference position) even if a user roughly sets a region of interest for setting the reference point, thereby preventing human error. Accordingly, the present disclosure may improve (or enhance) the accuracy and/or reliability of detecting a shape fault of the electrode tab. In addition, the present disclosure may reduce the downtime due to the human error (e.g., a period of time during which the system 1000 is stopped due to a large number of defective products being generated due to the human error). Further, the present disclosure may improve a yield of the secondary battery (e.g., improve the yield by preventing a good product from being determined as a defective product due to the human error).

In addition, the present disclosure may measure the bending radius and the cutting distance together using reference point information. Accordingly, the present disclosure may improve the speed and/or efficiency of detecting a shape fault of the electrode tab.

FIG. 7 is a block diagram illustrating the configuration of an apparatus for detecting a shape fault of an electrode tab of a secondary battery according to an embodiment of the present disclosure.

Referring to FIG. 7, an apparatus for detecting a shape fault of an electrode tab of a secondary battery (hereinafter, an electrode tab inspection apparatus) 700 according to an embodiment of the present disclosure may be the electrode tab inspection apparatus 200 of FIG. 1. The electrode tab inspection apparatus 700 may be located on one side of the processing apparatus 100 or the transfer apparatus 300 of FIG. 1. Alternatively, the electrode tab inspection apparatus 700 may be integrated with the processing apparatus 100 or the transfer apparatus 300 of FIG. 1.

According to an embodiment, the electrode tab inspection apparatus 700 may include a photographing module 710, an alarm module 720, a communication module 730, a display 740, a memory 750, and a processor 760.

The photographing module 710 (e.g., the camera) may photograph a subject (e.g., the secondary battery). For example, the photographing module 710 may photograph a side surface of the secondary battery to be inspected for a shape fault of the electrode tab, thereby acquiring a side surface image of the electrode tab processed (e.g., bent and cut) into the designated shape.

When the designated condition is satisfied, the alarm module 720 may generate an alarm in the designated manner. For example, when a shape fault of the electrode tab is detected by the processor 760, the alarm module 720 may generate an alarm. The alarm module 720 may generate at least one of a visual alarm (e.g., lighting a light emitting diode (LED), displaying an icon, displaying a pop-up window, etc.), an auditory alarm (e.g., outputting a sound effect) and a tactile alarm (e.g., generating a vibration). To this end, the alarm module 720 may include at least one of a light emitting diode, a display, a speaker, and a vibration motor.

The communication module 730 may communicate with an external device (e.g., the processing apparatus 100 and the transfer apparatus 300 of FIG. 1, and/or a portable terminal (e.g., a smart phone) of the manager) through wired or wireless communication. For example, the communication module 730 may receive a request for inspection of a shape fault of an electrode tab from the processing apparatus 100 configured to process the electrode tab into a designated shape.

In addition, the communication module 730 may notify the transfer apparatus 300 of the completion of the inspection when the shape fault of the electrode tab is completed. The transfer apparatus 300 that has been notified of the completion of the inspection may transfer the secondary battery on which the inspection has been completed to a location where the next process will be performed. As another example, the communication module 730 may transmit an alarm to notify an occurrence of the shape fault of the electrode tab to a designated external device (e.g., the smart phone of the manager).

The display 740 may display various screens (e.g., side surface images of the electrode tabs, and/or measurement results, etc.). According to some embodiments, the display 740 may include a touch panel for detecting an input of the user.

The memory 750 may store a program for controlling an operation of the electrode tab inspection apparatus 700 and/or information necessary to control the operation of the electrode tab inspection apparatus 700. The memory 750 may include an artificial intelligence model (e.g., a linear regression model) which generates an upper parallel line based on the upper boundary points of the cutting part of the electrode tab, and generates a lower parallel line based on the lower boundary points.

The processor 760 may control the overall operation of the electrode tab inspection apparatus 700. For example, the processor 760 may receive commands or instructions from the memory 750, and control each component according to the received commands or instructions to perform various functions. The processor 760 may be consist of a central processing unit (CPU), a micro control unit (MCU), a microprocessor unit (MPU), etc.

According to an embodiment, the processor 760 may control the configurations the electrode tab inspection apparatus 700 to inspect whether there is a shape fault of the electrode tab of the secondary battery 30, and generate an alarm to notify an occurrence of the shape fault of the electrode tab, which has been described in detail above with reference to FIGS. 3 to 6, and therefore will not be described in detail.

Meanwhile, the electrode tab inspection apparatus 700 may not include some of the above-described configurations, or may further include other configurations. For example, the electrode tab inspection apparatus 700 may not include the alarm module 720 and/or the display 740. As another example, the electrode tab inspection apparatus 700 may further include an input module for receiving an input (e.g., an operation command) of the user. As another example, some of the configurations of the electrode tab inspection apparatus 700 may be formed as separate external devices. For example, the photographing module 710 and/or the display 760 of the electrode tab inspection apparatus 700 may be formed as separate external devices.

The contents described above are merely an example of applying the principle of the present disclosure, and other configurations may be further included without departing from the scope of the present invention. For example, at least some of the various embodiments of the present disclosure described above may be combined.

What is claimed is:

1. A method for detecting a shape fault of an electrode tab of a secondary battery, the method comprising:
photographing a side surface of the secondary battery to acquire a side surface image of the electrode tab processed into a designated shape;
measuring a bending radius and a cutting distance of the processed electrode tab from the side surface image;
checking whether the bending radius and the cutting distance satisfy a designated reference radius and reference distance; and
if the bending radius and the cutting distance do not satisfy the reference radius and the reference distance, determining that the shape fault of the electrode tab has occurred.

2. The method according to claim 1, wherein the measuring step comprises:
setting a first region of interest to include a partial region of an end (hereinafter, a cutting part) of the processed electrode tab;
generating an upper parallel line corresponding to an upper end of the cutting part and a lower parallel line corresponding to a lower end in the first region of interest;
recognizing a first end point of the upper parallel line and a second end point of the lower parallel line;
setting a second region of interest to include a bending part of the processed electrode tab, and setting a third region of interest with a designated size within the second region of interest;
recognizing upper boundary points and lower boundary points of the bending part while moving the third region of interest by a designated unit;
determining a starting point and a peak point of the bending part based on the recognized upper boundary points and lower boundary points; and
calculating the bending radius and the cutting distance based on the determined starting point and peak point of the bending part.

3. The method according to claim 2, wherein the step of generating the upper parallel line and the lower parallel line comprises: generating a first straight line based on the upper boundary points of the cutting part of the electrode tab using a linear regression technique, and determining the generated first straight line as the upper parallel line; and
generating a second straight line based on the lower boundary points of the cutting part of the electrode tab using the linear regression technique, and determining the generated second straight line as the lower parallel line.

4. The method according to claim 2, wherein the step of determining the starting point of the bending part comprises determining an upper boundary point where a vertical distance from the upper parallel line starts to be a designated size or less among the recognized upper boundary points of the bending part as an upper starting point; and
determining a lower boundary point where a vertical distance from the lower parallel line starts to be a designated size or less among the recognized lower boundary points of the bending part as a lower starting point.

5. The method according to claim 4, wherein the step of calculating the cutting distance comprises calculating an upper tab distance between the first end point and a point where a straight line vertically extending from the upper starting point and the upper parallel line meet;
calculating a lower tab distance between the second end point and a point where a straight line vertically extending from the lower starting point and the lower parallel line meet; and
determining an average of the upper tab distance and the lower tab distance as the cutting distance.

6. The method according to claim 2, wherein the step of determining the peak point comprises determining an upper boundary point which has the largest vertical distance from the lower parallel line among the recognized upper boundary points of the bending part as the peak point.

7. The method according to claim 6, wherein the step of calculating the bending radius comprises calculating a vertical distance between the peak point and the lower parallel line; and
determining the calculated vertical distance as the bending radius.

8. The method according to claim 2, further comprising calculating a bending distance of the electrode tab based on the second end point and the peak point of the electrode tab.

9. The method according to claim 1, further comprising:
recognizing a pattern of a shape of the electrode tab from the side surface image; and
if the pattern is not recognized, generating an alarm to notify that the pattern recognition is not possible,
wherein, when the pattern is recognized, the measuring step is performed.

10. The method according to claim 1, further comprising, when it is determined that the shape fault has occurred, generating an alarm in a designated manner.

11. An apparatus for detecting a shape fault of an electrode tab of a secondary battery, the apparatus comprising:
a photographing module configured to photograph a side surface of the secondary battery to acquire a side surface image of the electrode tab processed into a designated shape; and
a processor configured to measure a bending radius and a cutting distance of the processed electrode tab from the side surface image, check whether the bending radius and the cutting distance satisfy a designated reference radius and reference distance, and if the bending radius and the cutting distance do not satisfy the reference radius and the reference distance, determine that the shape fault of the electrode tab has occurred.

12. The apparatus according to claim 11, wherein the processor sets a first region of interest to include a partial region of an end (hereinafter, a cutting part) of the processed electrode tab,
generates an upper parallel line corresponding to an upper end of the cutting part and a lower parallel line corresponding to a lower end in the first region of interest,
recognizes a first end point of the upper parallel line and a second end point of the lower parallel line,
sets a second region of interest to include a bending part of the processed electrode tab, and sets a third region of interest with a designated size within the second region of interest,
recognizes upper boundary points and lower boundary points of the bending part while moving the third region of interest by a designated unit,
determines a starting point and a peak point of the bending part based on the recognized upper boundary points and lower boundary points, and
calculates the bending radius and the cutting distance based on the determined starting point and peak point of the bending part.

13. The apparatus according to claim 12, wherein the processor generates a first straight line based on the upper boundary points of the cutting part of the electrode tab using a linear regression technique, and determines the generated first straight line as the upper parallel line, and
generates a second straight line based on the lower boundary points of the cutting part of the electrode tab using the linear regression technique, and determines the generated second straight line as the lower parallel line.

14. The apparatus according to claim 12, wherein the processor determines an upper boundary point where a vertical distance from the upper parallel line starts to be a designated size or less among the recognized upper boundary points of the bending part as an upper starting point, and
determines a lower boundary point where a vertical distance from the lower parallel line starts to be a designated size or less among the recognized lower boundary points of the bending part as a lower starting point.

15. The apparatus according to claim 14, wherein the processor calculates an upper tab distance between the first end point and a point where a straight line vertically extending from the upper starting point and the upper parallel line meet,
calculates a lower tab distance between the second end point and a point where a straight line vertically extending from the lower starting point and the lower parallel line meet, and
determines an average of the upper tab distance and the lower tab distance as the cutting distance.

16. The apparatus according to claim 12, wherein the processor determines an upper boundary point which has the largest vertical distance from the lower parallel line among the recognized upper boundary points of the bending part as the peak point.

17. The apparatus according to claim 16, wherein the processor calculates a vertical distance between the peak point and the lower parallel line, and determines the calculated vertical distance as the bending radius.

18. The apparatus according to claim 12, wherein the processor further calculates a bending distance of the electrode tab based on the second end point and the peak point of the electrode tab.

19. The apparatus according to claim 11, further comprising an alarm module configured to, when it is determined that the shape fault has occurred, generate an alarm in a designated manner.

20. A system for detecting a shape fault of an electrode tab of a secondary battery, the system comprising:
a processing apparatus configured to process the electrode tab of the secondary battery into a designated shape; and
an electrode tab inspection apparatus configured to photograph a side surface of the secondary battery through a photographing module to acquire a side surface image of the electrode tab processed into a designated shape, measure a bending radius and a cutting distance of the processed electrode tab from the side surface image, and compare the bending radius and the cutting distance with a designated reference radius and reference distance, respectively, to inspect whether there is a shape fault of the electrode tab.
